(19) United States
(12) Patent Application Publication
(10) Pub. No.: US 2007/0198410 A1
(43) Pub. Date: Aug. 23, 2007

(54) Credit fraud prevention systems and methods

(76) Inventors: Marc R. Labgold, Reston, VA (US); Lacy Kolo, Leesburg, VA (US); Brian Kolo, Leesburg, VA (US)

Correspondence Address: Lacy Kolo, 14591 Golden Oak Road, Centreville, VA, 20121, US

(21) Appl. No.: 11/582,544

(22) Filed: Oct. 18, 2006

Related U.S. Application Data
(60) Provisional application No. 60/727,494, filed on Oct. 18, 2005.

(51) Int. Cl. G06Q 40/00

(52) U.S. Cl. 705/44

(57) ABSTRACT

The present invention seeks to minimize, reduce and/or eliminate credit fraud, identity theft and erroneous the incurrence of charges. The present invention allows individuals and/or entities to passively authenticate credit/banking access in real-time. Embodiments of the invention includes methods, systems, programs, and/or methods of doing business for banking/credit transactions including, inter alia, credit card point of sale (“POS”) purchases, e-commerce, credit issuance and credit inquiries, which minimize or eliminate credit and identity theft.

### RELATED APPLICATIONS

This application claims priority to U.S. Ser. No. 60/727,494, filed Oct. 18, 2005.

### FIELD OF THE INVENTION

The present invention seeks to minimize, reduce and/or eliminate credit fraud, identity theft and erroneous the incurrence of charges. The present invention allows individuals and/or entities to passively authenticate credit/banking access in real-time. The present invention also provides means for reducing the economic loss associated with credit fraud, identity theft and erroneous and/or unauthorized transactions.

### BACKGROUND OF THE INVENTION

Modern banking relies heavily upon electronic transactions. This has only increased with the advances in electronic commerce (e-commerce). E-commerce alone has been projected to grow at a high rate and this will have a significant impact on the financial industry. At an ever-increasing rate, individuals and entities access their bank accounts electronically, typically via the internet or by other remote means including but not limited to automated teller machines (ATM). Similarly, individuals and entities conduct financial transactions electronically, typically over the internet or by other remote means. With the increase in electronic transactions and dependence of computerized methodology, there has been and continues to be an ever increasing problem of credit fraud, identity theft and erroneous charging, each of which can have dramatic adverse effects on the affected party. Also, use of ATM machines particularly those not associated directly with the ATM card issuing entity, are susceptible to fraud and theft of financial-related data. It has been recently indicated that identity theft is the fastest growing crime in the United States.

Common electronic transactions include, inter alia, credit card purchases. These credit card purchases include, but not limited to, electronic checks, check cards, ATM cards, bank cards, credit cards, gift certificate cards, and accounts administered over the Internet each of which can be at point of sale (POS) locations, telephonic, e-commerce such as online purchasing. Common electronic transactions also include credit inquiries such as those performed in advance of automobile financing, mortgages, credit card issuance, credit line issuance, debit card issuance, and the like. Further, common electronic transactions include use of so-called speed passes (passive or active transmission devices linked to a credit card or other account, examples of which include the MobileOil SpeedPass™, EZPass, cell phones, or similar devices) the uses of which is ever-increasing. Even further common electronic transactions can include electronic transfers of finds from one entity to another, and any other financial transaction conducted by electronic means and/or method. In the context of this invention, the phrase “credit card” is intended to encompass each of the forgoing devices unless otherwise indicated.

Credit cards, electronic checks, ATM cards, cash cards, gift cards, passive devices (such as speed passes), debit cards and check cards in particular have gained an expanded role in business, especially with the advent of e-commerce. Now, not only are these means accepted when presented in person at a store of a member merchant, but also in the total absence of a brick and mortar member merchant, the device or the person representing himself to be an authorized user. The vastly enhanced flexibility of use has come at a cost of increased credit fraud. A recent Post-ABC News poll revealed that 22% of the 1001 randomly sampled individuals had experienced some form of credit theft and misuse. The threat of fine and imprisonment is not always a sufficient deterrent to prevent fraud, and there has been a disproportionate increase in abuse against sales volume. To deter abuse, a number of anti-fraud initiatives have been instituted by credit card processors (i.e., Visa, Discover, American Express, MasterCard), fiduciary institutions (i.e., banks, credit unions, large vendors, governmental entities), and organizations that serve the fiduciary institutions and processors (i.e., telephone companies, software companies, computer manufacturers, secure service encryption providers).

By way of example, credit card companies have invested heavily in the minimization, reduction and prevention of credit card fraud, identity theft and erroneous transactions. Typical methods include the use of computer programs that monitor credit card activity for “atypical” usage. Such atypical usage can include, inter alia, increased purchasing, and unusual purchasing patterns (including amounts charged, frequency of charges, locations of charges, types of charges, etc.). Once an atypical pattern is observed, a credit warning is issued, typically by telephone to the credit card holder to confirm that the observed activity was intended by the credit card holder. Often the credit issuing institution will temporarily halt all activity on the credit card until such time that the credit card holder verifies the activity. U.S. Pat. No. 6,516,056 to Justice et al. discloses examples of such risk assessment methods.

Corporate and individual clients of banks and other financial institutions have traditionally accessed the electronic cash management systems of their banks by phone, fax, or dumb terminal at the low end of the service spectrum, and by SunOS™, Linux™, AIX™, UNIX, Microsoft Windows™, MacOS™ or DOS-based workstations at the high end. Recently, there has been an increase in the popularity of banking on the World Wide Web, as more and more businesses and individuals are recognizing the benefits of performing online transactions over the ever-growing Internet. With the recent explosion in e-commerce, the increasing acceptance of the Internet as a less expensive and more efficient way of doing business, and the advent of new server technology and sophisticated online security systems, online banking by both businesses and individuals is becoming ever more common. Banks desiring to stay competitive must therefore provide to their client's internet-based electronic cash management (ECM) services. According to a 1997 research study, most banks predicted that within a year they would be providing browser-based electronic banking services to their corporate and institutional clients. Despite the increased customer demand for such services, less than 2% of banking services were provided via a web browser, according to research in 1999. It has been predicted that by 2005, electronic transaction-based cash management revenue will reach $12.8 billion.

In the case of individuals, each of these transactions, inquiries, transfers or other electronic activity is typically linked to a Unique Identifier (UI) for each person or entity. In the United States, a common UI for an individual is that individual's social security number. For U.S. businesses, the UI is typically a tax identification number (e.g., TID, EIN or similar). However, any UI is intended to be encompassed by the present invention including, inter alia, an account number, customer number or similar individual identifier/code. The term “individual” as contemplated in the present invention is intended to include, without limitation, persons, corporations, partnerships, customers, end users, or any other legal entity.

With the increase in reliance upon electronic and computer-based transactions has come an increase in credit fraud, identity theft and erroneous credit charges, often resulting in significant economic loss for the creditor/banking institution and inconvenience and or economic loss for the party whose credit has been adversely affected.

An individual's credit/financial information is typically accessed by the fraudulent user by any of a number of different ways. For example, an individual's credit/information can be accessed by illegally accessing such information by hacking into the electronic networks employed for the transmission of such data. Such “hacking” can be as benign as so-called “social hacking”—accessing an unprotected wireless network by simply being within range of the signal. Additionally, individuals' credit/financial information can be accessed by the improper application for credit (by theft of SSN and other information followed by illegal application, theft of mailed applications, etc.). Once an initial theft has occurred, it is quite common for the fraudulent party to incur numerous charges, apply for additional credit in the fraud victim's name, access the victim's bank accounts and the like. Erroneous transactions typically occur by the mistaken entry of the wrong individual's account/credit information or by multiple entry of the same transaction.

Typically, such individuals have no knowledge of fraudulent, erroneous or unauthorized credit access or usage, theft of financial information, and/or, without limitation, the opening of false accounts in the individual's name, until the damage has been done and their credit has been significantly and adversely impacted.

In general, the cost of implementation of anti-fraud initiatives has been borne by the member merchants, small businesses, and individual authorized users. The member merchants have had to install much more sophisticated encryption transaction devices to confirm a sufficiency of credit in the card account, and update the member merchant of his own credit status. The encrypted communication prevents accidental disclosure of the details of the transaction to a potentially felonious, or otherwise interested, party. Authorized Users, whether individuals or businesses, have to provide more detailed personal and financial information, which can result in the very real perception in an unacceptable level of personal invasion of privacy, at a questionable level of overall reduced fraud.

The most common security measure to reduce fraud for a credit card is for a merchant to compare the signature of the customer to the signature on the back of the credit card. The merchant must then determine if the signatures “match” and decide if customer is the authorized user of the credit card. This visual authorization creates numerous problems for the merchant and the customer. The merchant is required to make a personal judgment as to whether the signatures match, and this personal judgment is influenced by the pressure to make a sale and retain good will in the community. In fact, most merchants, due to either time constraints or a desire to make sales goals, do not even look at the customer's signature at time of purchase. Furthermore, this method of matching signatures does not apply to purchases made by mail order, telephone, internet, and the like.

Another type of security measure to reduce fraud is the verification of the billing address of the credit card holder. The purchaser is required to enter his billing address along with his credit card information through the remote terminal. When the credit card purchase information is presented to the financial institution who issued the card, the institution compares the correct billing address with the purchaser's billing address to ensure they match. However, a thief who steals an individual's physical wallet will have access to their billing address and a thief who steals transaction information on-line may have access to the credit card holder's billing address. Therefore, address verification systems have not been successful in eliminating fraud.

A representative example of an invention designed to cut down on fraud is U.S. Pat. No. 6,095,413 to Tetro et al., disclose a method, wherein it is asserted that transactions are made more secure by checking the card account number against the user's social security number. The account number and the social security number, which are already in the bank's database, are kept in yet one more database, so that the two can be compared. Kevin Rowney et al, of VeriPhone, discloses in U.S. Pat. No. 5,987,140 an invention illustrative of a system having enhanced security using encrypted communication through “a plurality of computer systems” between the merchant, the customer and the requisite number of middlemen. The underlying theme of these anti-fraud initiatives is that the problem can be controlled with increasingly more robust security measures, where security measures involve a greater invasion of the cardholder's privacy to accomplish their goal. A necessary corollary to enhanced security is increased knowledge of the user. By contrast, a working caveat for the smooth flow of business is to keep any measure simple and cost effective. An extension of the historical approach tends to hurt business and raise privacy concerns, especially if the card issuer must bare responsibility for protecting the privacy of the protected information.

A resource for reducing fraud that has been generally overlooked is the potential contribution of the credit card account holder. An exception to that is Robert Checchio's U.S. Pat. No. 6,052,675, assigned to AT&T, Corporation. Checchio describes a method wherein, prior to a purchase, the card holder notifies a member association having a database processor, that he is going to make a purchase at X time for Y dollars from Z merchant. Then, when he actually makes the purchase, he just presents his card to the merchant, who contacts the member association for confirmation. While no doubt the foregoing method ought to reduce fraud, it is cumbersome and unpractical for general utility. Additionally, if for some reason the item had to be returned or was on backorder, then the transaction becomes much more complex. From the merchant's perspective, it would probably also require joining an additional member association. Finally, impulse buying is reduced or eliminated due to the cumbersome nature of the methodology and would negatively impact sales.

An ideal method of reducing fraud includes real-time, passive authentification to find if the person who requests the financial transaction, purchase, credit history access, or the like, is the person associated with the account. A representative example of an invention designed to cut down on fraud is U.S. Pat. No. 6,601,762 to Piotrowski, which discloses a method of using voice verification to authenticate a credit card user's identity. The verification system is located at the POS device and would verify identity before the transaction is approved. However, factors such as background noise, poor quality microphones, and inaccuracies of voice recognition software makes this invention difficult to enable.

To attract consumer, merchants and credit card issuers offer consumer's fast and convenient services such as cashless payment systems. These payment systems speed up financial transaction by use of Radio Frequency Identification (RFID) technology for data transfer. Of late, companies are increasingly embodying RFID data acquisition technology in a fob, tag or other similar form factor for use in completing financial transactions. One example is the Mobil Speedpass™, where the merchant issues the consumer a RFID tag that identifies the consumer by an ID number. When the customer pulls up to the gas pump, the RFID tag is interrogated to receive the ID number of the tag. The ID number is sent via satellite to a host computer, which authenticates the tag. The consumer then receives gas, and the host computer charges the purchase amount to the consumer's credit card. A typical RFID tag or fob includes a transponder and is ordinarily a self-contained device, which may be contained on any portable form factor. In some instances, a battery may be included with the fob to power the transponder, in which case, the internal circuitry of the fob (including the transponder) may draw its operating power from the battery power source. Alternatively, the fob may exist independent of an internal power source. In this instance, the internal circuitry of the fob (including the transponder) may gain its operating power directly from a RF interrogation signal. U.S. Pat. No. 5,053,774, issued to Schuermann, describes a typical transponder RF interrogation system, which may be found in the prior art. The Schuermann patent describes in general the powering technology surrounding conventional transponder structures. U.S. Pat. No. 4,739,328, issued to Koelle, et al., discusses a method by which a conventional transponder may respond to a RF interrogation signal. Other typical modulation techniques, which may be used, include, for example, ISO/IEC 14443 and the like.

Obviously, the methods to prevent fraud are not effective. The present invention provides a means for reducing credit fraud by having the consumer passively authenticate financial transaction. A method where the authorizes user participates in the administration of his credit and banking accounts is preferred and would provide significant security for the end user as well as the lending/issuing/banking institution. Additionally, the present invention provides a means for reducing the risk to the lending/credit institution.

The technology of electronic commerce has adopted a number of terms that are helpful to define to better understand the prior art and the invention. A short glossary of such terms follows:

Acquirer—The financial institution (or an agent of the financial institution) that receives from the merchant the financial data relating to a transaction authorizes the transaction, obtains the funds from the issuer, and pays those funds into a merchant financial account. The acquiring institution can act as its own merchant certificate authority (MCA) or can contract with a third party for service.

Authentication—In computer security, the process used to verify the identity of a user or the user's eligibility to access an object; verification that a message has not been altered or corrupted; a process used to verify the user of an information system or protected resources.

Authorization—In payment card systems, the process used to verify that a credit or debit account is valid and holds sufficient credit or funds to cover a particular payment. Authorization is performed before goods or services are provided, in order to ensure that the cardholder credit can support payment.

Bank—a depository financial institution that provides services relating to the storing of money and extending of credit. A bank may handle checking and savings accounts and deal in negotiable instruments.

Browser—A computer program that allows a user to read hypertext messages such as HTML pages on the World Wide Web.

Capture—In payment card systems, the process used by a merchant to claim payment from an issuing bank via an acquiring bank. Capture is performed after goods and services are provided. Optionally, capture may be combined with authorization in the case where goods or services are provided at the time of authorization.

Cardholder—A person who has a valid payment card account and uses software that supports electronic commerce. Also known as a shopper, online shopper, consumer, or buyer.

Certificate—A document issued by a trusted party that serves as physical evidence of the identity and privileges of the holder. Usually used as synonymous with an electronic certificate or digital certificate since an actual document is of little value in a world of electronic commerce.

Certificate authority (CA)—an organization that issues certificates. The CA responds to the actions of a Registration Authority (RA) and issues new certificates, manages existing certificates, renews existing certificates, and revokes certificates belonging to users who are no longer authorized to use them.

Certificate chain—a hierarchy of trusted digital certificates that can be “chained” or authenticated back to the “chain's” ultimate trust level—the top of the hierarchy called the “root certificate.”

Credit holder—A person or entity who has a valid credit dossier. Also known as a shopper, online shopper, consumer, or buyer.

Digital certificate—An electronic document digitally signed by a trusted party. The digital certificate binds a person's or entity's unique name to a public/private key pair.

Digital signature—Data that is appended to, or is a cryptographic transformation of, a data unit. Digital signature enables the recipient of the data unit to verify the source and integrity of the unit and to recognize potential forgery.

Digital wallet or Consumer wallet—Software that works like a physical wallet during electronic commerce transactions. A wallet can hold a user's payment information, a digital certificate to identify the user, and shipping information to speed transactions. The consumer benefits because his or her payment information is handled securely and because some wallets will automatically input shipping information at the merchant's site and will give the consumer the option of paying by digital cash or check. Merchants benefit by receiving protection against fraud. The wallet is used to protect and store credit/debit information, protect the transmission of that information to only the people that are authorized to see it and to authenticate the cardholder.

Issuer—a financial institution that issues payment cards to individuals. An issuer can act as its own cardholder certificate authority (CCA) or can contract with a third party for the service.

Key pair—In computer security, a matched set of public and private keys. When used for encryption, the sender uses the public key half to encrypt the message, and the recipient uses the private key half to decrypt the message. When used for signing, the signer uses the private key half to sign a message, and the recipient uses the public key half to verify the signature.

Merchant server—a Web server that offers cataloged shopping services. The equivalent to a physical store.

Password—For computer or network security, a specific string of characters entered by a user and authenticated by the system in determining the user's privileges, if any, to access and manipulate the data and operations of the system.

Payment card—a credit card or debit card that is issued by a financial institution and shows a relationship between the cardholder and the financial institution.

Registration authority (RA)—An organization or person authorized or licensed to authenticate a certificate requestor's identity and the services that the requester is then authorized to use. The RA approves requests so that certificates can be issued, renewed, updated, or revoked by a CA. The RA is usually a credit officer of an issuing or acquiring bank and approves the certificate requests for its members.

Secure Sockets Layer—A security protocol that allows the client to authenticate the server and all data and requests to be encrypted. SSL offers a very limited trust model and a secure link between client and server.

Thin wallet—generally the digital wallet program resides on the user's PC, but a “thin” wallet places some of the wallet function on a server, thereby reducing the program size on the user's PC and enabling an easier modification of the wallet's features.

Trusted Root—the base or top level certificate that provides the basis for the trusted hierarchy.

The so-called SET Secure Electronic Transaction™ (trademark and service mark owned by SET Secure Electronic Transaction LLC) protocol has been developed as a means of increasing the security of bankcard transactions over public networks. SET is an open standard, multi-party protocol for conducting secure payments over the Internet. SET provides message integrity, authentication of all financial data, and encryption of sensitive data.

The SET protocol is a 4-party protocol involving a cardholding consumer, a merchant, and a payment gateway operating on behalf of the acquiring bank, as shown in FIG. 1. When a consumer 190 is ready to buy something from a merchant on the internet using a credit or debit card, the consumer's computer 102 sends a consumer payment request over internet path 120 to the merchant's computer 104, in a first step. The merchant's computer 104 forwards the consumer's payment request over internet path 122 during a second step to an acquirer gateway 106 operating on behalf of the acquirer bank 108. The acquirer gateway 106 passes the consumer's payment request to the acquirer bank 108 over a private network path 122′. The acquirer bank 108 sends the consumer's payment request to the card-issuing bank 112 over the private network path 124 to check whether the consumer's credit or debit card account is active and sufficient for the proposed transaction with the merchant. The issuing bank 112, as the card issuer, authorizes the transaction in a message sent over private path 126 to the acquiring bank 108. The acquiring bank 108 sends the transaction authorization over private path 128′ to the acquirer gateway 106, signing the message with the acquiring bank's digital signature. The acquirer gateway 106 forwards it over the internet path 128 to the merchant, authorizing the merchant to proceed with the transaction. Once the merchant has received the transaction authorization from the acquirer gateway 106, the merchant completes the sales transaction with the consumer. Then later, the merchant sends a message over internet path 142 to the acquirer gateway 106 to capture the transaction and be paid. The acquirer gateway then sends a payment message over path 144 to the merchant. The acquiring bank 108 may participate in some or all of the payment steps at the end of the business day when the acquiring bank will settle accounts with the issuing bank 112 over the private network.

Some implementers of SET are providing “thin” wallets, where all or some of the wallet function are implemented in server systems rather than in consumer-controlled machines. Where the wallet servers are run by issuing banks, it would be desirable to have the wallet servers directly authorize transactions before they are submitted to merchants. This would save the time and complexity required when the merchants obtain authorization from issuers through the merchant's acquiring banks. It would also be desirable to expand the cardholder authentication methods supported by the SET protocol, to enable an issuer to independently choose alternate authentication mechanisms without changing the acquirer gateway. As with any system, it would also be desirable to simplify the SET protocol in order to enable its easier implementation and to improve its overall performance. It would also be desirable to provide a generally applicable method of reducing credit fraud, identity theft and erroneous and/or unauthorized transactions.

### SUMMARY OF THE INVENTION

Embodiments of the invention disclosed herein includes a method, system, program, and method of doing business for banking/credit transactions including, inter alia, credit card point of sale (“POS”) purchases, e-commerce, credit issuance and credit inquiries, which minimize or eliminate credit and identity theft. The term POS transactions is intended to encompass, without limitation, in-store credit card transactions, electronic check transactions, telephone transactions, ATM transactions, and credit history/record access. One embodiment of the current invention utilizes a Unique Identifier (“UI”) to identify the individual. The UI can be, for example, a social security number, EIN or TID used for banking, credit and/or taxation purposes. In summary, this embodiment utilizes the UI to track all credit card purchases, debit card purchases, banking card purchases, banking transactions, credit inquiries, credit issuance and like transactions and provides for notifying the individual of each credit/financial information related event. The current invention also utilizes a readable electronic tag, issued by the bank, merchant, credit issuer to the customer or purchased by the consumer himself. Anytime account or information that is linked to the UI is accessed, such as in a credit card purchase or credit check, the customer's readable electronic tag, otherwise known as an authorization device, must be present for the access to be approved.

It is therefore an object of certain embodiments of the present invention to provide a passive authentication system whereby credit fraud is reduced and/or eliminated.

Another object of certain embodiments of the present invention is to provide a passive authentication system whereby banking fraud is reduced or eliminated.

Another object of certain embodiments of the present invention is to provide a passive authentication system whereby identity theft is reduced or eliminated.

Another object of certain embodiments of the present invention is to provide a passive authentication system whereby the effects of erroneous financial transactions is reduced or eliminated.

In one embodiment, the passive authentication occurs at every transaction. In another embodiment, the passive authentication occurs when a pre-set parameter is met. The pre-set parameter can be, for example, a monetary limit or a type of merchant.

Another object certain embodiments of the present invention is to provide a passive authentication system whereby the individuals' readable electronic tag is present for the approval applications for credit.

Another object of certain embodiments of the present invention is to provide a passive authentication system whereby the individuals' readable electronic tag is present for approval of credit inquiries.

Another object of certain embodiments of the present invention is to provide a passive authentification system whereby the individuals' readable electronic tag is present for approval of access to an individual's financial information.

Another object of certain embodiments of the present invention is to provide a passive authentification system whereby the individuals' readable electronic tag is present for approval of usage of an individual's financial information.

Other objects of the present invention will be readily apparent to those of ordinary skill in the relevant art from the disclosure contained herein.

Another object of a preferred embodiment of the invention is to provide a passive authentification system whereby the individuals' readable electronic tag is present for approval of credit/banking information access.

The instant invention can be implemented at any stage of the transaction prior to access being granted to the end user's financial information or credit-related information/accounts.

If privacy is desired, the methods and systems of the present invention can include a means for protecting the transmitted information such as Secure Socket Layer (SSL) or other encryption/security protocol. The credit card can be used to transmit two way encryption in any way, including for example, the encryption in U.S. Pat. Nos. 6,671,810 and 6,084,969.

### DESCRIPTION OF THE FIGURES

FIG. 1 illustrates the prior art SET four-party protocol lacking the passive authentification features of the present invention.

FIG. 2 illustrates the prior art SET four-party protocol with the passive authentification features of the present invention.

FIG. 3 illustrates the prior art three-party protocol lacking the passive authentification features of the present invention.

FIG. 4 illustrates the prior art three-party protocol with the passive authentification features of the present invention.

FIG. 5 illustrates a credit card transaction with the passive authentification features of the present invention.

FIG. 6 illustrates a transaction authorization sequence with the passive authentification features of the present invention.

FIG. 7 illustrates a secure online credit card transaction with the passive authentification features of the present invention.

FIG. 8 illustrates a credit access request in accordance with the passive authentification features of the present invention.

FIG. 9 illustrates a credit application in accordance with the passive authentification features of the present invention.

FIG. 10 illustrates an ATM transaction with the passive authentification features of the present invention.

FIG. 11 illustrates a third-party notification service to provide the passive authentification features of the present invention.

FIG. 12 illustrates a computer system for matching the transaction information and the authorization information.

FIG. 13 illustrates a load balanced computer system using a gateway server for processing notifications in accordance with the present invention.

FIG. 14 illustrates a load balanced computer system using a router for processing notifications in accordance with the present invention.

FIG. 15 illustrates a system with a plurality of access authorization systems working in conjunction consistent with the present invention.

### DETAILED DESCRIPTION OF THE PREFERRED EMBODIMENTS

It will be appreciated by those skilled in the art that although the following Detailed Description will proceed with reference being made to preferred embodiments, the present invention is not intended to be limited to these embodiments.

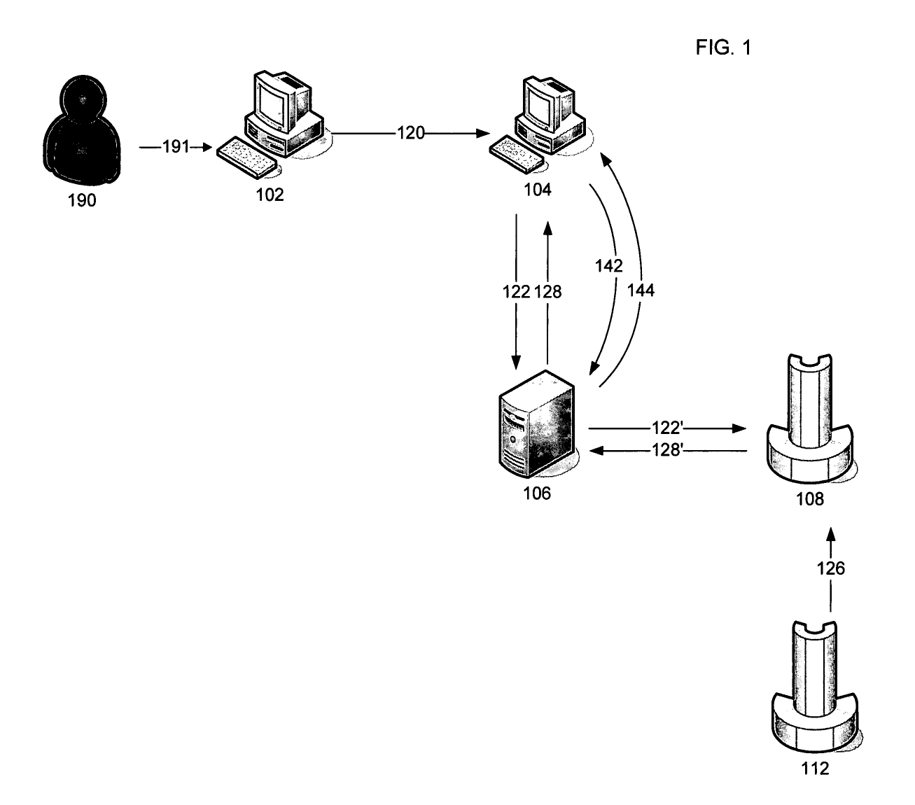

FIG. 1 illustrates a 4-party protocol. As previously described, the 4-party protocol involves a cardholding consumer, a merchant, and a payment gateway operating on behalf of the acquiring bank. When a consumer 190 makes an online purchase, the consumer's computer 102 sends a consumer payment request over internet path 120 to the merchant's computer 104, in a first step. The merchant's computer 104 forwards the consumer's payment request 122 to an acquirer gateway 106 operating on behalf of the acquirer bank 108. The acquirer gateway 106 passes the consumer's payment request to the acquirer bank 108 over a private network path 122′. The acquirer bank 108 sends the consumer's payment request to the card-issuing bank 112 over the private network path 124 to verify the consumer's credit or debit card account is active and sufficient for the proposed transaction with the merchant. The issuing bank 112, as the card issuer, authorizes the transaction in a message sent over private path 126 to the acquiring bank 108. The acquiring bank 108 sends the transaction authorization over private path 128′ to the acquirer gateway 106, signing the message with the acquiring bank's digital signature. The acquirer gateway 106 forwards it over the internet path 128 to the merchant, authorizing the merchant to proceed with the transaction. Once the merchant has received the transaction authorization from the acquirer gateway 106, the merchant completes the sales transaction with the consumer. Then later, the merchant sends a message over internet path 142 to the acquirer gateway 106 to capture the transaction receive payment. The acquirer gateway then sends a payment message over path 144 to the merchant. The acquiring bank 108 may participate in some or all of the payment steps. Then, at the end of the business day, the acquiring bank will settle accounts with the issuing bank 112 over the private network.

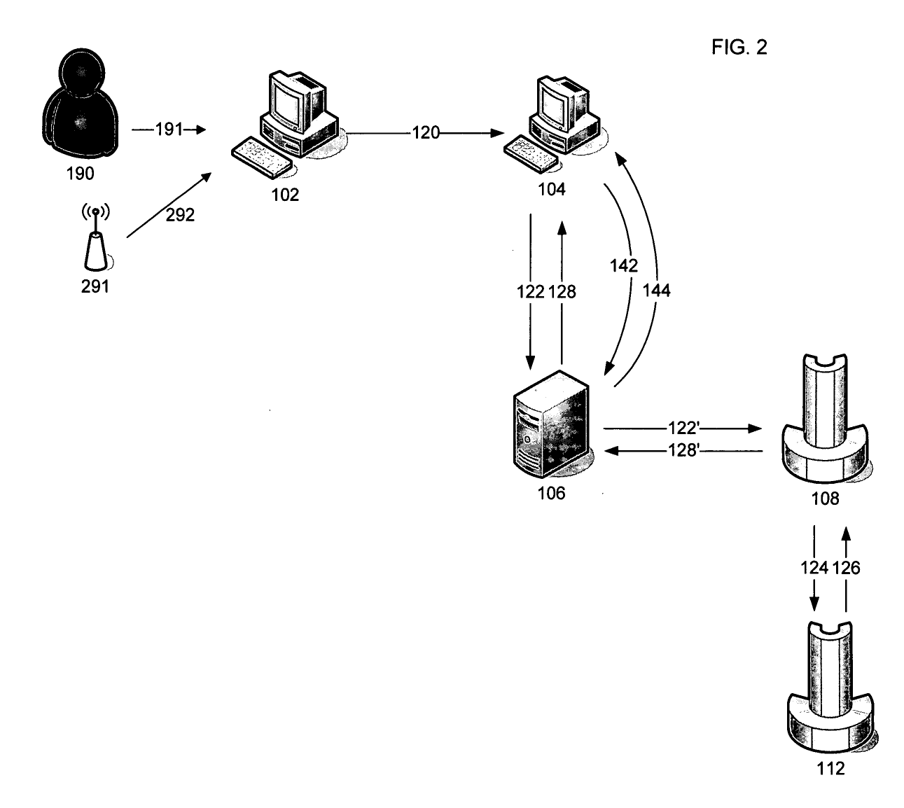

FIG. 2 illustrates a preferred embodiment of the invention. FIG. 2 is the 4-party protocol of FIG. 1 with the addition of the passive authentication from the authorizing device (291). When the consumer (190) orders an item online, the authorizing device (291) sends a signal with authorization information (292), by any of the electronic means in accordance with the present invention, to the consumer's computer (102). Alternatively, the authorization information (292) is displayed by the authorizing device (291) and manually entered by the consumer. The transaction information and the authorization information is forwarded (120) to the merchant's computer (104). The merchant's computer (104) forwards the transaction information and the authorization information to an acquirer gateway (106) operating on behalf of the acquirer bank (108). The acquirer gateway 106 passes the transaction information and the authorization information to the acquirer bank (108) over a private network path (122′). The acquirer bank (108) sends the transaction information and the authorization information to the card-issuing bank (112) over the private network path (124) to verify whether the consumer's credit or debit card account is active and sufficient for the proposed transaction with the merchant and to verify that the authorization information is associated with the credit or debit card account. The issuing bank (112), as the card issuer, authorizes the transaction in a message sent over private path (126) to the acquiring bank (108), where the approval or rejection information is forwarded back to the consumer's computer (102). Further, it is also recognized that the matching of the authentification information with the credit or debit card account can occur via a third-party vendor who monitors such transactions, where such third-party vendor can access information at any point along the chain of the transaction.

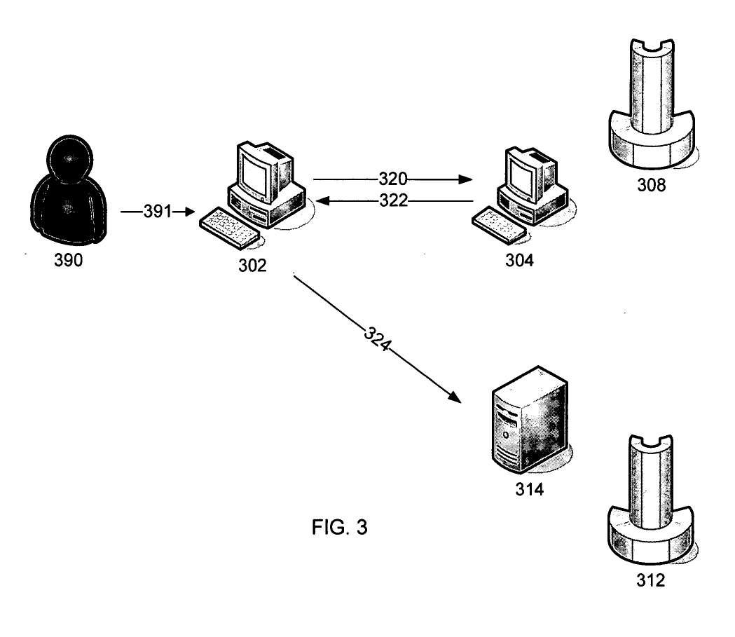

FIG. 3 illustrates a 3-party protocol. A principal feature of the protocol is providing an issuer gateway and moving the credit/debit card authorization function from the merchant to the issuer thus enabling pre-authorization of payments initiated over the internet. The prior art 3-party protocol method starts with the step of sending the transaction request 391 made by a consumer 390 from the consumer's computer 302. The transaction request also includes a start message 320 over an internet network to a merchant's computer 304. The merchant's computer 304 then replies to the consumer's computer 302 with a merchant message 322 including a wallet initiation message, a merchant digital signature, and a digital certificate from an acquiring bank 308. The wallet initiation message includes a payment amount, an order description, a timestamp, and a nonce. This starts a consumer's wallet program in the consumer's computer 302 in response to the wallet initiation message. The consumer's computer 302 then sends a message 324 over the internet network including some consumer identity and authentication information, such as a user id and user password, plus the merchant message, to an issuer gateway 314 operating on behalf of an issuing bank 312. The prior art method, however, fails to provide the electronic notification of the present invention and is limited in scope to internet transactions. The method does not prevent the identity theft, which can occur through hacking. Through hacking, an unauthorized user can access the confidential information without the consumer's knowledge.

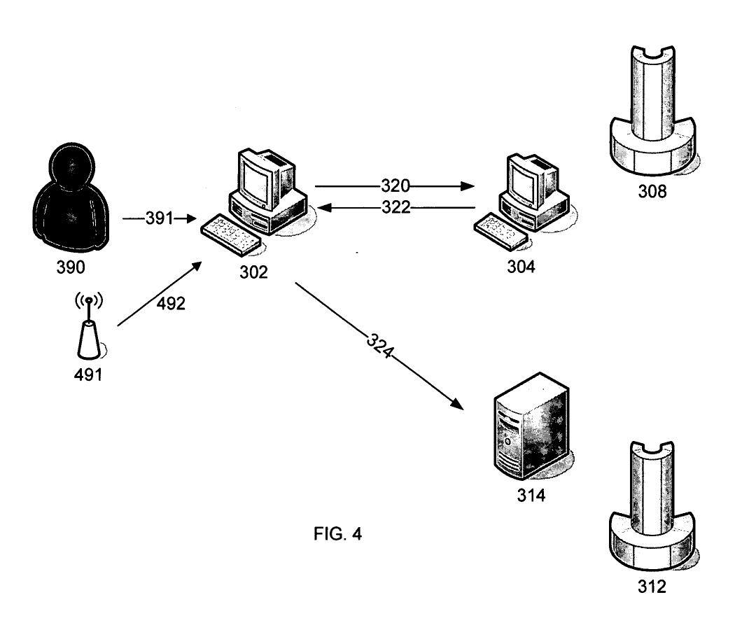

FIG. 4 illustrates a preferred embodiment of the invention. FIG. 4 is the 3-party protocol of FIG. 3 with the addition of the passive authentification from the authorizing device (491). When the consumer (390) orders an item online, the authorizing device (491) sends a sends a signal with authorization information (492), by any of the electronic means in accordance with the present invention, to the consumer's computer (302). Alternatively, the authorization information (492) is displayed by the authorizing device (491) and manually entered by the consumer. The transaction information and the authorization information is forwarded (320) to the merchant's computer (304). The merchant's computer (304) then replies to the consumer's computer (302) with its merchant message (322) that includes the transaction information, the authorization information, a wallet initiation message, a merchant digital signature, and a digital certificate from an acquiring bank (308). This message (322) initiates the consumer's wallet program in the consumer's computer (302), where the consumer's computer (302) then sends the message (324) to the issuer gateway (314) operating on behalf of the issuing bank (312). The issuer gateway (314) then verifies that the consumer's credit or debit card account is active and sufficient for the proposed transaction with the merchant and verifies that the authorization information is associated with the credit or debit card account. Further, it is also recognized that the matching of the authentification information with the credit or debit card can occur via a third-party vendor who monitors such transactions, where such third-party vendor can access information at any point along the chain of the transaction.

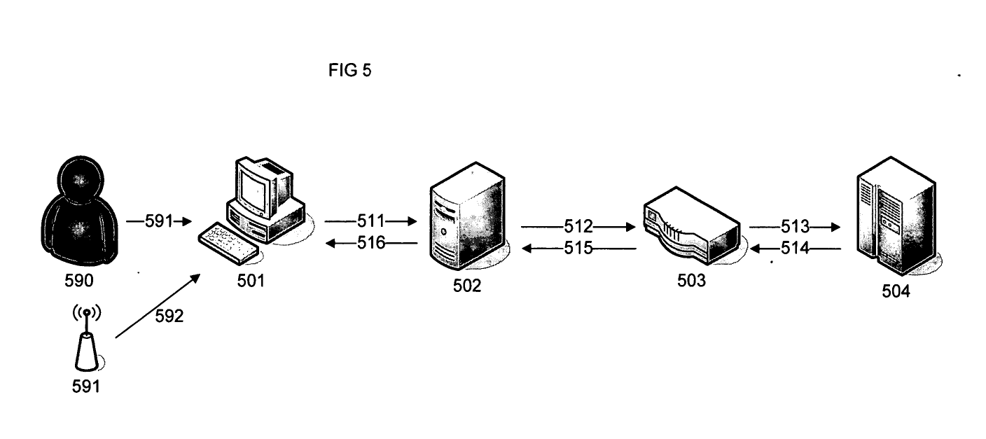

In FIG. 5, a credit card transaction in accordance with the present invention is presented. A consumer (590) initiates a transaction (591) with a merchant (501). The authorizing device (591) sends a signal with authorization information (592), by any of the electronic means in accordance with the present invention to the merchant (501). Alternatively, the authorization information (592) is displayed by the authorizing device (591) and is manually entered by the consumer. The merchant (501) sends the request for account transaction or access (“transaction information”) and the authorization information to an acquirer (502) via a first communication line (511). The acquirer (502) sends the transaction information and the authorization information to the merchant banking system (503) via a second communication line (512). The merchant banking system (503) contacts the consumer's bank (504) and forwards the transaction information and the authorization information via a third communication line (513). The consumer's bank (504) then verifies that the consumer's credit or debit card account is active and sufficient for the proposed transaction with the merchant and verifies that the authorization information is associated with the credit or debit card account. The consumer's bank (504) approves or disapproves the transaction and sends a notification via a forth communication line (514) to the banking system (503). The banking system (503) processes the notification and transmits a notification via a fifth communication line (515) to the acquirer (502). The acquirer (502) transmits a notification via a sixth communication line (516) to the merchant (501). Further, it is also recognized that the matching of the authentification information with the credit or debit card can occur via a third-party vendor who monitors such transactions, where such third-party vendor can access information at any point along the chain of the transaction.

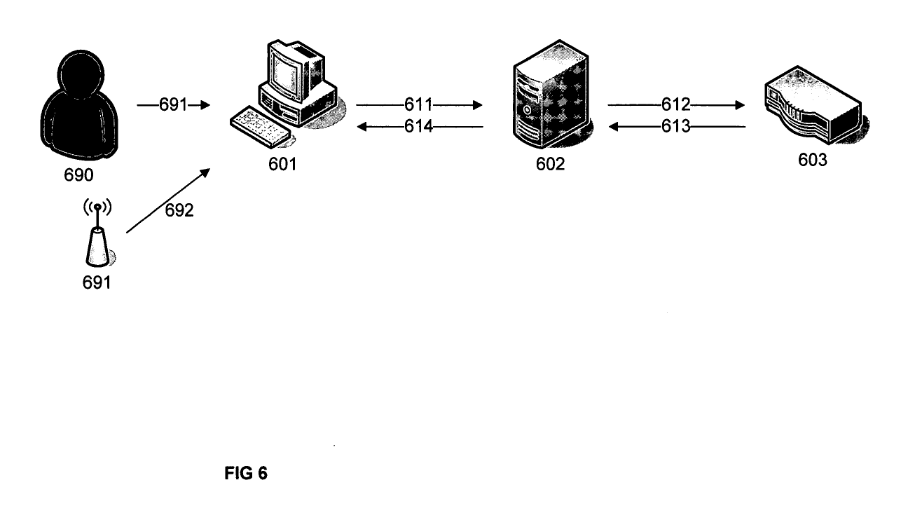

FIG. 6 shows an authorization sequence in accordance with the present invention. A consumer (690) initiates a transaction with a merchant (601). The authorizing device (691) sends a signal with authorizing information (692), by any of the electronic means in accordance with the present invention, to the merchant (601). Alternatively, the authorization information (692) is displayed by the authorizing device (691) and manually entered by the consumer. The merchant (601) contacts an acquirer (602) and sends the transaction information and the authorization information via a first communication line (611). The acquirer (602) sends the transaction information and the authorization information to an authorization system (603) via a second communication line (612). The authorization system (603) verifies that the consumer's credit card account is active and sufficient for the proposed transaction with the merchant and verifies that the authorization information is associated with the credit or debit card account. The authorization system (603) then sends notification of the approval or disapproval of the transaction via a third communication line (613) to the acquirer (602). The acquirer (602) sends notification of the approval or disapproval of the transaction to the merchant (601) along a fourth communication line (614). Further, it is also recognized that the matching of the authentification information with the credit or debit card can occur via a third-party vendor who monitors such transactions, where such third-party vendor can access information at any point along the chain of the transaction.

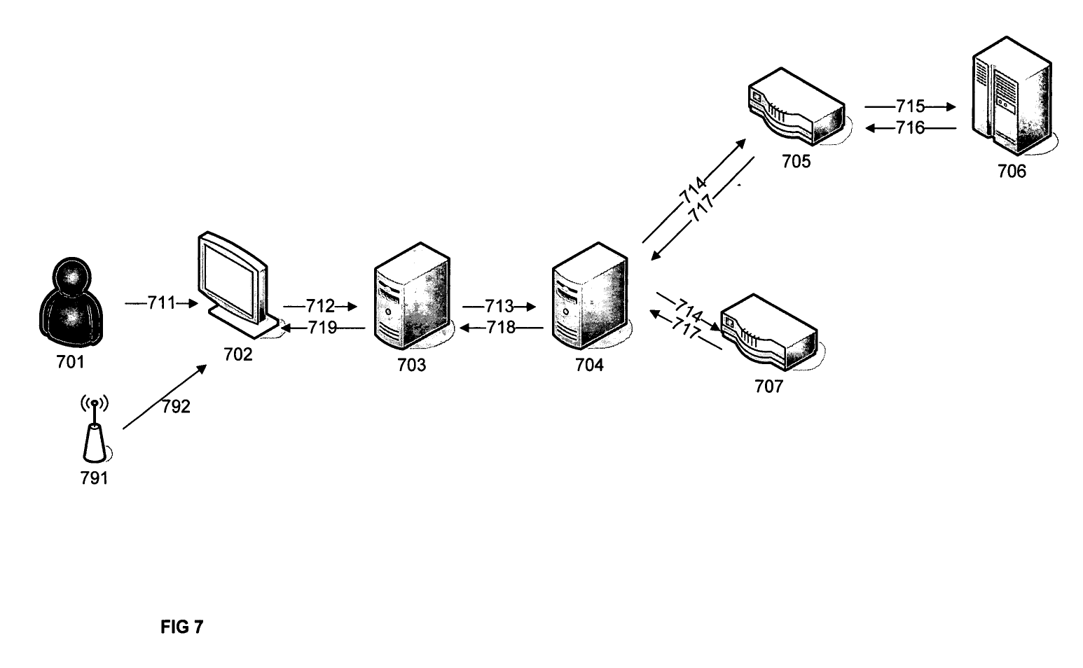

FIG. 7 shows a secure online credit card transaction in accordance with the present invention. A consumer (701) initiates a transaction (711) with a merchant (702). The authorizing device (791) sends a signal with authorization information (792), by any of the electronic means in accordance with the present invention, to the merchant (701). Alternatively, the authorization information (792) is displayed by the authorizing device (791) and manually entered by the consumer. The merchant (702) sends the transaction information and the authorization information to a gateway (703) via a first communication line (712). The gateway (703) sends the transaction information and the authorization information to an acquirer (704) via a second communication line (713). The acquirer (704) processes the transaction information and the authorization information and sends a request to an appropriate authorization system. This may be a banking system (705), an authorization system (707), or a similar system capable of authorizing the transaction. In the case of a banking system (705), the acquirer (704) sends the transaction information and the authorization information to the banking system (705) via a third communication line (714). The banking system (705) sends the transaction information and the authorization information to the consumer's bank (706) via a fourth communication line (715). The consumer's bank (706) verifies that the consumer's credit card account is active and sufficient for the proposed transaction with the merchant and verifies that the authorization information is associated with the credit or debit card account. The consumer's bank (706) then approves or disapproves the transaction and sends a notification via a fifth communication line (716) to the banking system (705). The banking system (705) processes the notification and transmits a notification via a sixth communication line (717) to the acquirer (704). In the case of an authorization system (707), the acquirer (704) sends a notification to the authorization system (707) via a seventh communication line (714). The authorization system (707) processes the authorization requests and approves or disapproves the transaction and sends a notification via an eighth communication line (717) to the acquirer (704). The acquirer (704) processes the notification and sends a notification to the gateway (703) via a ninth communication line (518). The gateway processes the notification and sends a notification to the merchant (702) using a tenth communication line (719). The merchant (702) may send a notification of approval or rejection to the consumer (701) via an eleventh communication line (720). Further, it is also recognized that the matching of the authentification information with the credit or debit card can occur via a third-party vendor who monitors such transactions, where such third-party vendor can access information at any point along the chain of the transaction.

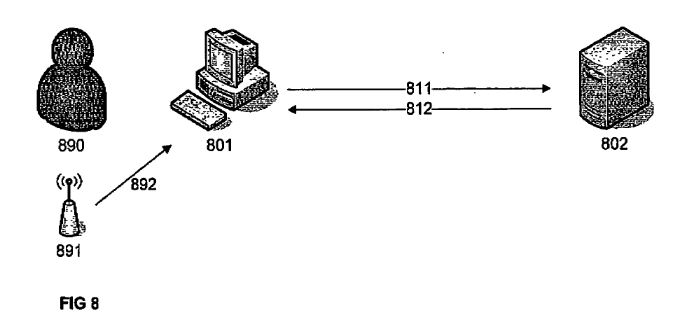

In FIG. 8, a typical credit access request in accordance with the present invention is presented. When the request for access to the individual's credit history or record is undertaken from such sources as Equifax, TRW, or other credit-reporting agency, the consumer must have the authorizing device present to grant access to the credit history or record. In FIG. 8, a user (809) uses a computer (801) to contact a credit agency (802) via a first communication line (811). The authorizing device (891) sends a signal with authorization information (892), by any of the electronic means in accordance with the present invention, to the computer (801). Alternatively, the authorization information (892) is displayed by the authorizing device (891) and manually entered by the consumer. The credit agency (802) verifies that the consumer's personal information is associated with authorizing device. The credit agency (802) processes the request and sends the results to the user's computer (801) via a second communication line (812). It is recognized that the matching of the authentification information with the consumer's personal information can occur via a third-party vendor who monitors such transactions, where such third-party vendor can access information at any point along the chain of the transaction.

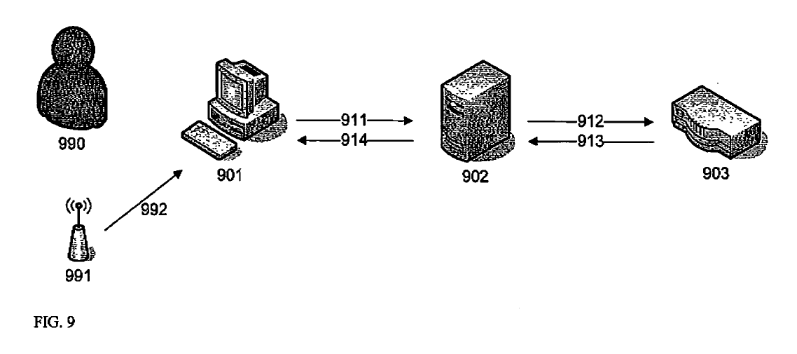

In FIG. 9, a typical credit application in accordance with the present invention is presented. When a user (990) applies for credit or credit card, the user (990) submits credit application information via computer (901). The authorizing device (991) sends a signal with authorization information (992), by any of the electronic means in accordance with the present invention, to the computer (901). Alternatively, the authorization information (992) is displayed by the authorizing device (991) and manually entered by the user. The computer (901) transmits the credit application information and the authorizing information via a first communication line (911) to the bank (902). The bank then requests access to the credit information from a credit bureau (903) via a second communication line (912). The credit bureau (903) then transmits the credit information to the bank (902) via a third communication line (913). The bank (902) then approves or rejects the credit application and transmits this information via fourth communication line (914) to the computer (901). It is recognized that the bank (902) or the credit agency (903) can verify that the consumer's personal information is associated with authorizing device. It is further recognized that the matching of the authentification information with the consumer's personal information can occur via a third-party vendor who monitors such transactions, where such third-party vendor can access information at any point along the chain of the transaction.

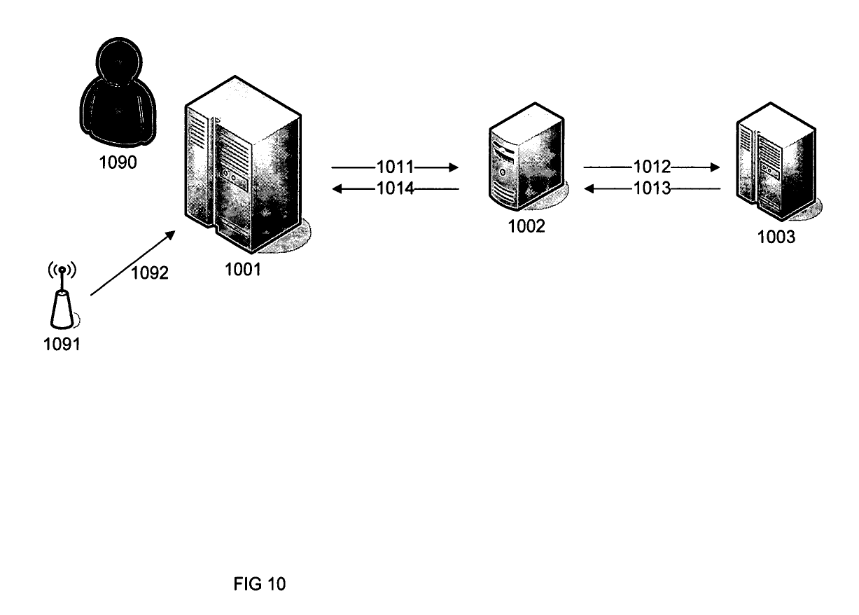

In FIG. 10, a typical ATM transaction accordance with the present invention is presented. A request for transaction is made by a user (1090) on an ATM (1001). The authorizing device (1091) sends a signal with authorization information (1092), by any of the electronic means in accordance with the present invention, to the ATM. Alternatively, the authorization information (1092) is displayed by the authorizing device (1091) and manually entered by the consumer. The ATM sends the transaction information and the authorization information to an ATM Bank (1002) via a first communication line (1011). The ATM Bank (1002) sends the transaction information and the authorization information to the card-issuing bank (1003) via a second communication line (1012). The card-issuing bank (1003) verifies that the consumer's credit card account is active and sufficient for the proposed transaction and verifies that the authorization information is associated with the credit account. The card-issuing bank (1003) approves or disapproves the transaction and sends a response to the ATM Bank (1002) via a third communication line (1013). The ATM Bank (1002) processes the response and sends a notification to the ATM (1001) via a fourth communication line (1014). It is recognized that the matching of the authentification information with the consumer's personal information can occur via a third-party vendor who monitors such transactions, where such third-party vendor can access information at any point along the chain of the transaction.

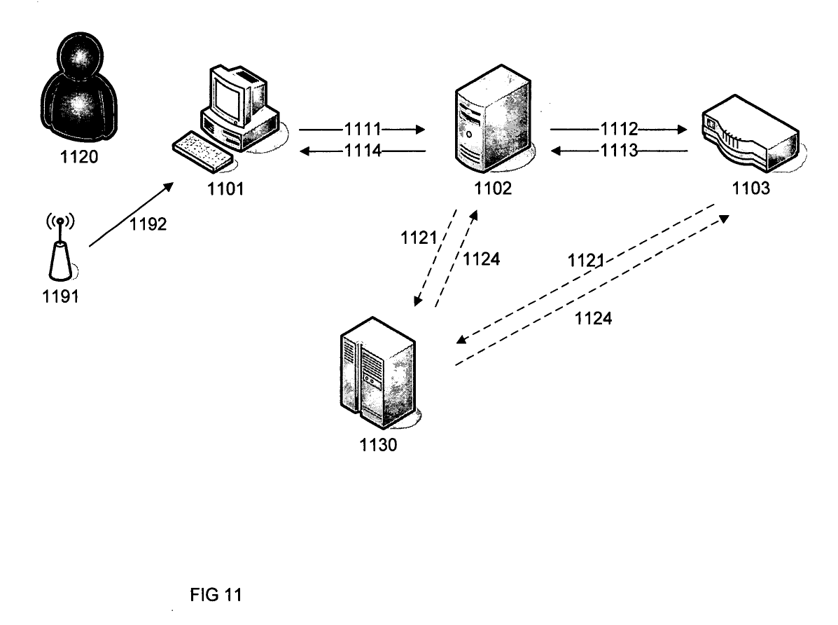

FIG. 11 shows an example of a third-party notification service in accordance with the present invention. In this embodiment, the matching of the authorization information and the transaction information does not occur by an entity in the transaction chain; rather a third party provides the service of matching the authorization information and the transaction information. For instance, in FIG. 11 a consumer (1190) requests a financial transaction with a merchant (1101). The authorizing device (1191) sends a signal with authorization information (1192), by any of the electronic means in accordance with the present invention, to the merchant (1101). Alternatively, the authorization information (1192) is displayed by the authorizing device (1191) and manually entered by the consumer. The merchant (1101) sends to the acquirer (1102) via a first communication line (1111) the transaction information and the authorizing information. The acquirer (1102) the transaction information and the authorizing information to an authorization system (1103) via a second communication line (1112). The authorization system (1103) approves or disapproves the transaction information and sends a notification via a third communication line (1113) to the acquirer (1102). The acquirer (1102) processes the notification and sends a notification to the merchant (1101) along a fourth communication line (1114). A merchant (1101), acquirer (1102), authorization system (1103), or any other participant in the authorization process may transmit the transaction information and the authorization information to the third-party entity (1130) via a fifth communication (1121). The third party entity (1130) then verifies that the consumer's transaction information matches the authorization information. The third party entity (1130) then notifies the merchant (1101), acquirer (1102), authorization system (1103), or any other participant in the authorization process.

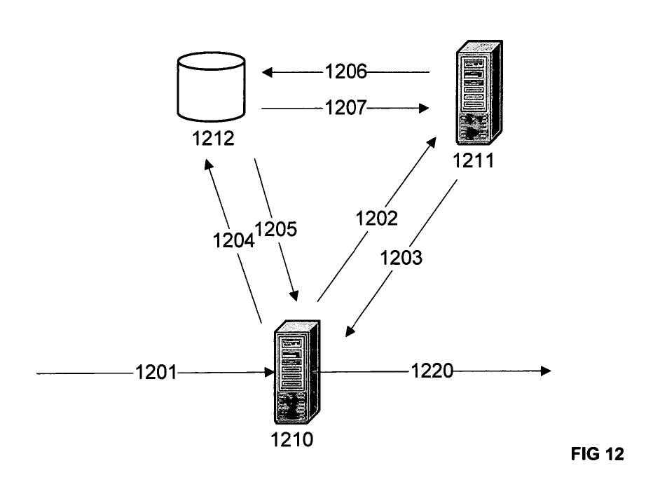

FIG. 12 is an example of a computer system for matching the transaction information and the authorization information. A request for the matching of the transaction information and authorization information (1201) is presented to an access server (1210). In a preferred embodiment, the access server (1210) sends the transaction information and authorization information to an access processing server (1211) using a first communication line (1202). The access processing server (1211) uses a second communication line (1206) to request information from a data store (1212). The data store processes the request and responds using a third communication line (1207). The access processing server (1211) process the information, matches the transaction information and the authorization information with the data store information, and computes a response allowing or disallowing the transaction. This response is sent to the access server using a fourth communication line (1203). The access processing server processes the response and outputs a response message using a fifth communication line (1220).

It is contemplated in less preferred embodiments that the access server (1210) processes the request and computes the response without use of the access processing server (1211). In one embodiment, the access server requests information directly from the data store (1212) through a sixth communication line (1204). The data store processes the request and responds using a seventh communication line (1205). The access processing server processes the response and outputs a response message using a fifth communication line (1220).

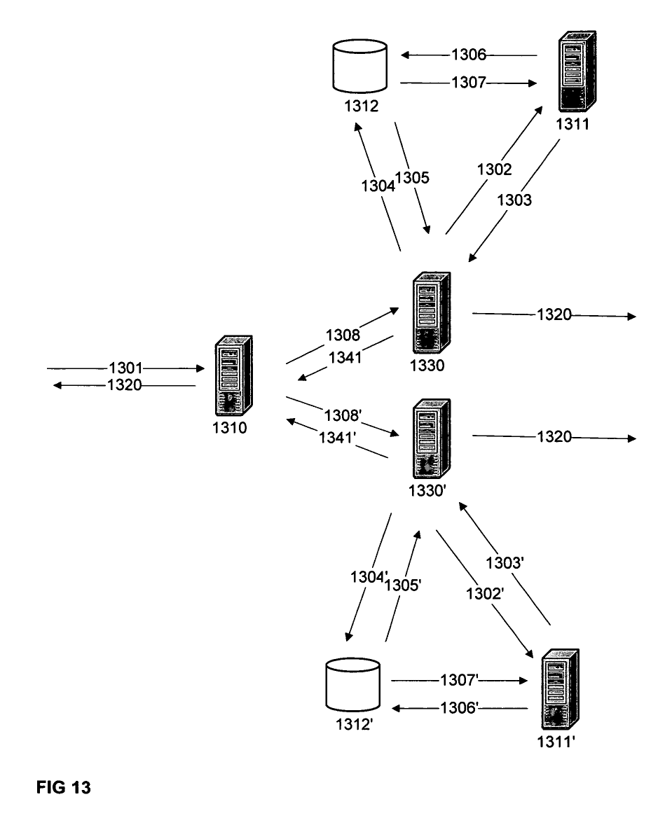

FIG. 13 shows an example of a load balanced computer system for processing notifications in accordance with the present invention. A request to match the transaction information and authorization information (1301) is presented to an access gateway server (1310). In a preferred embodiment, the access gateway server (1310) load balances requests over a plurality of access servers (1330, 1330′). The access gateway server (1310) chooses an appropriate access server (1330, 1330′) and sends a message using an eighth communication line (1308, 1308′). The access server (1330, 1330′) sends an access request message to an access processing server (1311, 1311′) using a first communication line (1302, 1302′). The access processing server (1311, 1311′) uses a second communication line (1306, 1306′) to request information from a data store (1312, 1312′). The data store processes the request and responds using a third communication line (1307, 1307′). The access processing server (1311, 1311′) process the information, compares the transaction information and authorization information against its data stores information, and computes a response allowing or disallowing the transaction. This response is sent to the access server using a fourth communication line (1303, 1303′). The access processing server processes the response and outputs a response message using a fifth communication line (1320).

It is contemplated in less preferred embodiments that the access server (1330, 1330′) processes the request and computes the response without use of the access processing server (1311, 1311′). In this embodiment, the access server requests information directly from the data store (1312, 1312′) through a sixth communication line (1304, 1304′). The data store processes the request and responds using a seventh communication line (1305, 1305′). The access processing server processes the response and outputs a response message using a fifth communication line (1320).

In the preferred embodiment, the data stores (1312, 1312′) are realized in a single data store. However, it is contemplated in a less preferred embodiment to use a redundant set of data stores.

In the preferred embodiment, the output response message is sent from the access server (1330, 1330′). However, it is contemplated in a less preferred embodiment for the output response message to be sent from the access gateway server (1310). In this embodiment, the access server (1330, 1330′) sends the response message to the access gateway server (1310) using a ninth communication line (1341, 1341′). The access gateway server process the response message and sends an output response using the fifth communication line (1320).

Although FIG. 13 shows load balancing over two access servers, it is contemplated that this system is distributed over a plurality of access servers, access processing servers, data stores, and communication lines. Each set may be configured in identical units (such as a data server and access server combination), or each unit may be configured differently. For instance, one unit may involve a single data server and a single access processing server, another unit may have the data server and access processing server residing on a single computer, while another unit may have two or more access processing servers with a single data server, etc.

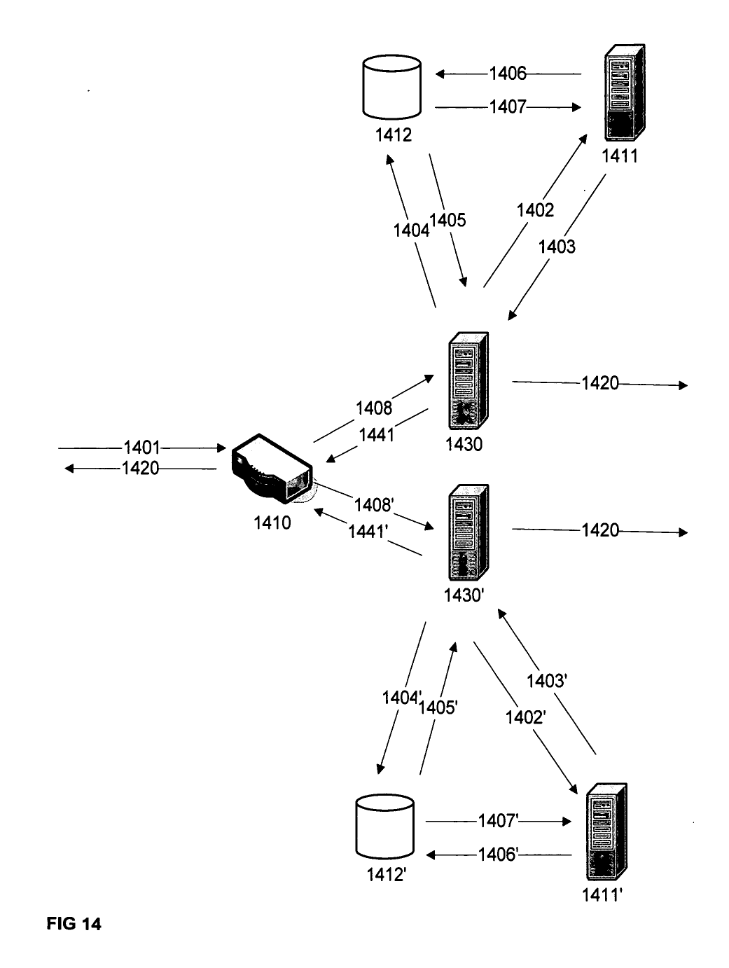

FIG. 14 shows an example of a load balanced computer system for processing notifications in accordance with the present invention. An access request message containing authorization information and transaction information (1401) is presented to an access gateway router (1410). In a preferred embodiment, the access gateway router (1410) load balances the request over a plurality of access servers (1430, 1430′). The access gateway router (1410) chooses an appropriate access server (1430, 1430′) and sends a message using an eighth communication line (1408, 1408′). The access server (1430, 1430′) sends an access request message to an access processing server (1411, 1411′) using a first communication line (1402, 1402′). The access processing server (1411, 1411′) uses a second communication line (1406, 1406′) to request information from a data store (1412, 1412′). The data store processes the request and responds using a third communication line (1407, 1407′). The access processing server (1411, 1411′) process the information, matches the authorization information and transaction information to the data store information, and computes a response allowing or disallowing the transaction. This response is sent to the access server using a fourth communication line (1403, 1403′). The access processing server processes the response and outputs a response message using a fifth communication line (1320).

It is contemplated that in one embodiments that the access server (1430, 1430′) processes the request and computes the response without use of the access processing server (1411, 1411′). In this embodiment, the access server requests information directly from the data store (1412, 1412′) through a sixth communication line (1404, 1404′). The data store processes the request and responds using a seventh communication line (1405, 1405′). The access processing server processes the response and outputs a response message using a fifth communication line (1420).

In one preferred embodiment, the data stores (1412, 1412′) are realized in a single data store. However, it is contemplated in a less preferred embodiment to use a redundant set of data stores.

In one preferred embodiment, the output response message is sent from the access server (1430, 1430′). However, it is contemplated in another embodiment for the output response message to be sent from the access gateway router (1410). In this embodiment, the access server (1430, 1430′) sends the response message to the access gateway server (1410) using a ninth communication line (1441, 1441′). The access gateway server process the response message and sends an output response using the fifth communication line (1420).

Although FIG. 14 shows load balancing over two access servers, it is contemplated that this system is distributed over a plurality of access servers, access processing servers, data stores, and communication lines. Each set may be configured in identical units (such as a data server and access server combination), or each unit may be configured differently. For instance, one unit may involve a single data server and a single access processing server, another unit may have the data server and access processing server residing on a single computer, while another unit may have two or more access processing servers with a single data server, etc.

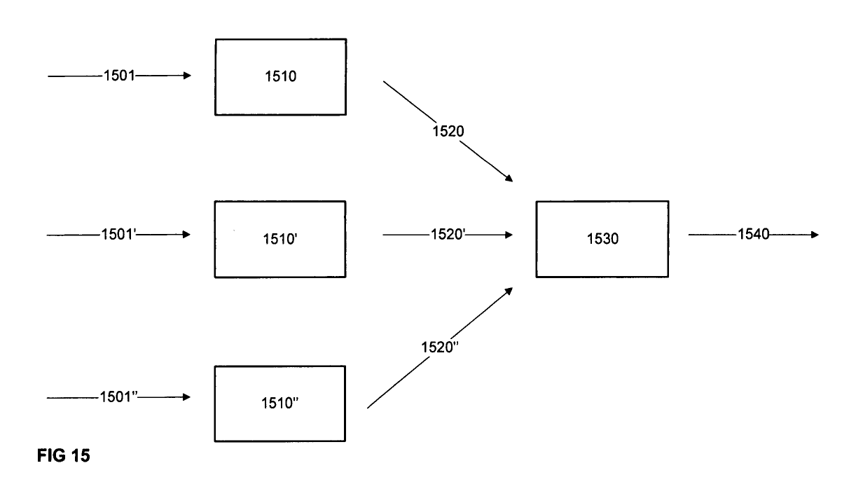

FIG. 15 shows a system with a plurality of access authorization systems (1510, 1510′, 1510″) working in conjunction consistent with the present invention. In this embodiment, a single transaction is analyzed by a variety of access authorization systems (1510, 1510′, 1510″). Each access authorization system (1510, 1510′, 1510″) individually analyzed the transaction information and authorization information and computes an allowed/disallowed response for the transaction. The response for each system is relayed to a master access system (1530) which analyzed the responses and computes a allowed/disallowed response. Each of the access authorization systems (1510, 1510′, 1510″) and the master access system (1530) represents a system such as those discussed in FIGS. 12, 13, and 14. These systems may be any combination of systems similar to the systems described in FIGS. 12, 13, and 14. An access request (1501, 1501′, 1501″) is presented to the system. The access authorization system (1510, 1510′, 1510″) process the request and sends a response message to a master access system (1530) using a first communication line (1520, 1520′, 1520″). The master access system (1530) processes the response messages and allows or disallows the transaction. The master access system (1530) communicates the result along a second communication line (1540).

Although FIG. 15 shows three access authorization systems and a single master access system, it is contemplated that there may be one or more access authorization systems and/or a plurality of master access systems. Also, a plurality of master access systems may communicate to another master access system. This process may continue to scale to include a plurality of master access systems that eventually produce a allowed/disallowed result for the transaction.

It if further contemplated that the data store mentioned in any of the previous embodiments may be a single database residing on a single server, multiple databases residing on a single data store, or a distributed database residing on a plurality of servers. In addition, in a less preferred embodiment, the data store may reside on the access server or the access processing server. In addition, in a less preferred embodiment, the data store may reside on the access server or the access processing server. Furthermore, it is envisioned that one or more datastore will be at the same location or remote from one another.

It is also contemplated that the communication lines mentioned in any of the previous embodiments may use an Internet, intranet, extranet, WAN, LAN, satellite communication, cellular phone communications, communications on a motherboard, and the like. It is also contemplated that the message processing provided at the ends of the communication lines mentioned in the previous embodiments may include direct network communications using a communication protocol such as TCP/IP, IPX, RFC 793, or another standard or proprietary communication protocol. Furthermore, it is envisioned that the communication lines may communicate between electrical devices, databases, computers, and the like, which are located in different countries. Furthermore, the message processing may include simple message communications, remote procedure calls or other distributed application messages, Web Messaging, Web Services, MSMQ, MQ Series, XML messages, file transfers, or the like.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various entities. It should be noted that many alternative or additional functional relationships or physical connections may be present in a practical electronic transaction or transmission.

It is contemplated that in some embodiments, steps will be accomplished outside of U.S. territory. Thus, the inventors fully contemplate claims wherein a signal is sent out of or into U.S. territory. This signal is considered to be part of the invented subject matter, as is this signal's further manipulation to achieve one or more objects of the invention set forth above.

It should also be appreciated that the transmission of the authorization information from the authorizing device can occur by any electronic means, including but limited to RFID, satellite communication, cellular phone communications, and the like. IN one preferred embodiment, the electronic means occurs by RFID. RFID tags come in various shapes, sizes and read ranges including thin and flexible “smart labels” which can be laminated between paper or plastic. RFID creates an automatic way to collect information about a product, place, time or transaction quickly, easily and without human error. It provides a contactless data link, without need for line of sight or concerns about harsh or dirty environments that restrict other automatic ID technologies such as bar codes. In addition, RFID is more than just an ID code, it can be used as a data carrier, with information being written to and updated on the tag easily. Examples of RFID tags can be found in U.S. Pat. Nos. 6,851,617, 5,682,143, 4,654,658, 4,730,188 and 4,724,427.

It should also be appreciated that the transmission of the authorization information from the authorization device can occur by manual entry. It is contemplated that the authorization device displays an number or password that changes periodically, such as, for example, SecurID™. The device is synched to a database held by a thrid party provider, bank, or other authentication entity. The benefit of such authorization device is even a thief gets one's number or password, the change in number or password results in disabling the thief from using the number or password.

It should be appreciated that the network described herein may include any system for exchanging data or transacting business, such as Internet, intranet, extranet, WAN, LAN, satellite communication, cellular phone communications, and the like. Further, the communications between entities concerning the transaction or access request can occur by any mechanism, including but not limited to, Internet, intranet, extranet, WAN, LAN, point of interaction device (point of sale device, personal digital assistant, cellular phone, kiosk, etc.), online communication, off line communication, and wireless connection. The present invention might further employ any number of conventional techniques for data transmission, signaling, data processing, network control, and the like. For example, radio frequency and other wireless techniques can be used in place of any network technique described herein.

It is further contemplated that a third party vendor or service may be involved with the transaction, access and/or action chain in any of the embodiments, where the third party vendor or service tracks any activity associated with the person or corporation with the unique identifier, compares the authorization information to the transaction information, and notifies any person along the chain of the transaction. It is contemplated that notification of such response will result in approval or rejection of the transaction, access request, or action request.

It is contemplated that the merchant's bank may be the same bank as the credit card issuer's bank. It is further contemplated that communications can occur sequentially, in parallel, or that two or more communications may be sent as one communication.

In each of the above embodiments, the different, specific embodiments of invention to prevent fraudulent credit card transactions are disclosed. However, it is the full intent of the inventor of the present invention that the specific aspects of each embodiment described herein may be combined with the other embodiments described herein. Those skilled in the art will appreciate that various adaptations and modification of the preferred embodiments can be configured without departing from the spirit and the scope of the invention. Therefore, it is to be understood that the invention may be practiced other than that specifically described therein.

1. Method for passively authenticating an account transaction or request, said method comprising:
programming at least authorizing device with at least one piece of authorization information associated with an account;
storing the at least one piece of authorization information onto a database;
receiving at least one request for an account transaction or access;
detecting the at least one piece of authorization information from the at least one authorizing device;
comparing the at least one request for account transaction or access with the authorization information stored onto a database;
whereby the at least one request is granted if the at least one piece of authorization information is associated with the account.

2. The method of claim 1, whereby the at least one request for an account transaction or access is denied if the at least one authorizing device is not detected.

3. The method of claim 1, whereby said detecting the at least one piece of authorization information occurs in real time.

4. The method of claim 1, whereby said authorizing agent is informed of the at least one request for account transaction or account access in real-time.

5. The method of claim 1, whereby said comparing the at least one request for account transaction or access with the authorization information stored onto a database occurs by a third party vendor that does not hold the account.

6. The method of claim 1, wherein said at least one account transaction is a credit card transaction.

7. The method of claim 1, wherein said at least one account access is access to a credit report.

8. System of passively authenticating an account transaction or request, said system comprising:
at least one database comprising a first authorization information associated with at least one account and a second authorization information associated with said at least one account;
at least one authorizing device programmed with said second authorization information;
software adapted to receive an electronic request from a consumer for at least one transaction with or access to said at least one account;
software adapted to receive an electronic signal from said at least one authorizing device, whereby said electronic signal comprises said second authorization information;
software adapted to compare said second authorization information received from an authorizing device with said first authorization information associated with at least one account;
software adapted to approve the account transaction or request if said first authorization information is matched with said second authorization information.

9. The system of claim 8, further comprising a second database, whereby said second authorization information associated said at least one account is stored on said second database.

10. The system of claim 8, whereby said account transaction is a credit card transaction.

11. The system of claim 8, wherein said account access is access to a credit report.
